(19) United States
(12) Patent Application Publication
(10) Pub. No.: US 2008/0216383 A1
(43) Pub. Date: Sep. 11, 2008

(54) HIGH PERFORMANCE NANO-METAL HYBRID FISHING TACKLE

(76) Inventors: David Pierick, San Diego, CA (US); Andy Brutlag, Carlsbad, CA (US); William F. Davidson, Huntington Beach, CA (US); Edward Hughes, Encinitas, CA (US)

Correspondence Address: FAY SHARPE LLP, 1100 SUPERIOR AVENUE, SEVENTH FLOOR, CLEVELAND, OH, 44114, US

(21) Appl. No.: 12/043,710

(22) Filed: Mar. 6, 2008

Related U.S. Application Data
(60) Provisional application No. 60/893,440, filed on Mar. 7, 2007.

(51) Int. Cl. A01K 87/00; B05D 1/12

(52) U.S. Cl. 43/18.1 R; 427/180; 43/24; 242/223

(57) ABSTRACT

Fishing tackle is coated with nanostructured material to modify and improve the performance. The fishing tackle includes a fishing rod which is coated adjacent a first end section, in a middle section, adjacent a second end section, or over an entire surface to improve the action, power or any performance characteristic and/or decrease weight. The fishing tackle includes a fishing reel which is coated in whole or part with a nanostructured material to improve strength, corrosion resistance or performance and/or decrease weight. The fishing tackle includes a fishing rod guide which is coated with a nanostructured material to improve performance and/or decrease weight. The area of coverage and thickness of the material coated on each component of the fishing tackle can be changed, as stipulated by design criterion.

The present application claims priority to U.S. Ser. No. 60/893,440, filed Mar. 7, 2007, the disclosure of which is incorporated herein.

### BACKGROUND

The invention generally relates to fishing tackle which includes fishing rods, reels, reel seats, lures and other fishing related equipment such as pliers, nets and etc. More particularly, this invention relates to improving the performance of the article by producing a hybrid material design that can add significant strength, reflex, durability, or corrosion resistance by using a hybrid material composition that includes a substrate of any organic or inorganic material with an application of nanostructured material.

### BRIEF DESCRIPTION

Due to the competitive nature of many sports, players are often seeking ways to improve sports equipment. Along this regard, manufacturers have sought out different materials and designs to enhance sports equipment. As can be appreciated, finding a suitable combination of materials and designs to meet a set of performance criteria is a challenging task.

Aspects of the present invention relate to fishing tackle including rods, reels, guides, and other fishing components. Various problems and opportunities for improvement are typically present in fishing components, as described in further detail below. Fishing rods are typically made out of fiber-reinforced (FRP) composite materials with an epoxy resin system. The inherent advantage of FRP composites is their light weight, flexibility and strength. Yet these systems have disadvantages including the inability of most FRP composites to withstand even minimal impact such as from the side of a boat or from rocks, sharp pieces of metal, and weights and lures from the end of the fishing line. Other problems with FRP composites include difficulty in manufacturing “variable action” for casting and reeling. Typically, a small taper in the diameter of the rod is used to modify the action, but this also weakens the power, and makes the rod more susceptible to breakage. The FRP composites also tend to over dampen the mechanical vibrations initiated by fish biting or during the reeling action, thus reducing the rod's sensitivity.

Fishing rod guides are used to direct the fishing line with high end guides made from metals, ceramics, and combinations thereof. The metals used for guides have poor friction coefficients, impairing the ability of the line to move smoothly over the guide, while ceramic guides tend to be brittle and break easily. Both metal and ceramic guides on the market today can also wear the line during repeated casting and reeling due to these tribological properties.

Fishing reels are used to deploy and retrieve the fishing line. Fishing reels are typically made out of aluminum or thermoplastic polymer. While aluminum and polymers have good strength to weight ratio, they must have certain minimum cross-sectional widths in order to provide that strength. In addition, aluminum scratches and corrodes easily and can be easily damaged by small impacts. Polymer reels, reel bodies and reel seats are also available to lower the price or weight, but this causes a sacrifice in the stiffness or durability of the reel. Under great loads, a reel may also be strained to the point of causing damage whether it is made from aluminum alloys or polymers.

Stone inscriptions from Egypt, China, Greece and Rome indicate the use of fishing rods to catch fish. Before the current day graphite and polymer materials, the fishing rods were made most typically from bamboo, reed, or ash wood. The butts were made from hard wood and the guides were made of bent wire. Various patents have addressed the design and manufacture of fishing rods as indicated below:

Ahn, in U.S. Pat. No. 7,043,868, discloses a fishing rod strengthened with a metal wire where the metal wire is co-cured with the composite material. This relates to a non-continuous metal fiber.

Tokuno, in U.S. Pat. No. 4,133,708, discloses a method to produce a thermoset plastic fishing rod with glass fiber, but does not describe the use of a metal or, specifically, a nanostructured metal in a hybrid system.

Suzue, et al., in U.S. Pat. No. 5,665,441, disclose the use of a perforated metallic member bonded to the periphery of the main body of the rod.

Higuchi, in U.S. Pat. No. 4,178,713, discloses the use of fiber reinforced resin laminations, including a space retainer in order to reduce the rod weight and provide high stiffness.

Palumbo, et al., in U.S. Pat. No. 7,320,832, disclose the use of fine grained metallic materials wherein the alloy is chosen such that the CTE (coefficient of Thermal Expansion) matches the substrate, thereby improving the de-lamination performance.

McIntosh, in U.S. Pat. No. 5,601,892, discloses the use of nickel coated graphite fibers in fishing rods and other sporting equipment.

Muroi, et al., in U.S. Pat. No. 4,305,981, disclose the use of a metallic decorative film with a substrate or polyurethane.

Manabe, et al., in U.S. Pat. No. 4,104,432, disclose the use of a protective metal film on molded plastics.

Gaehde, et al., in U.S. Pat. No. 4,005,238, disclose a process where the adhesion between a metalized polymer and the substrate is improved.

Soshiki, et al., in U.S. Pat. No. 4,180,448, disclose a process where a polymer article exhibits a metal finish with a high luster.

Nishimura, in U.S. Pat. No. 7,051,965, discloses a fishing reel where a paint coat is applied to the substrate in order to provide a mirroring effect.

The earliest patents for making nanostructured metals using electro-deposition processes are U.S. Pat. No. 5,352,266 and U.S. Pat. No. 5,433,797 to Erb et al. These patents disclose a process for producing nanostructured metals and alloys having a grain size of less than 100 nanometers.

Schulz et. al., in U.S. Pat. No. 6,051,046 and U.S. Pat. No. 6,277,170, disclose nanostructured nickel based alloys having grain size less than 100 nanometers.

Hui, in U.S. Pat. No. 6,200,450, discloses a method for electrodepositing a nickel-iron-tungsten phosphorous alloy to promote wear resistance.

Taylor et. al., in U.S. Pat. No. 6,080,504, disclose a method for depositing nanostructured particles of a catalytic metal on an electrically conductive substrate.

Gonsalves in U.S. Pat. No. 5,589,011, discloses a steel powder having a grain size in the nanometer range, specifically in the 50 nanometer size, and the steel powder is an alloy composed of iron, chromium, molybdenum, vanadium and carbon.

Gonsalves in U.S. Pat. No. 5,984,996, discloses nanostructured steel, aluminum, aluminum oxide, aluminum nitride, and other metals having crystallite size ranging from 45 nanometers to 75 nanometers.

Gonsalves in U.S. Pat. No. 6,033,624, discloses a chemical synthesis method for producing nanostructured metals, metal carbides and metal alloys.

Palumbo et. al., in U.S. Patent Publication 2006/0135281, disclose a shaft or face plate that is formed using fine grained metallic materials.

It is against this background that a need arose to develop the fishing tackle described herein.

### SUMMARY

In one aspect, the invention relates to a variety of fishing tackle including rods, reels, reel seats and guides, collectively herein called “fishing tackle.” The fishing tackle can be any of a variety of sports equipment and associated components, such as a tackle boxes, ferrules, guides, fishing pliers and knives and other fishing tackle accessories.

In one embodiment, the fishing tackle includes a portion that includes a nanostructured material. The nanostructured material includes a metal, and the nanostructured material has an average grain size that is in the range of 2 nm to 5,000 nm, a yield strength that is in the range of 200 MegaPascal (“MPa”) to 2,750 MPa, and a hardness that is in the range of 100 Vickers to 2,000 Vickers.

In another embodiment, the fishing tackle includes an electro-deposited or electro-formed fine-grained metal or metal alloy coating having a thickness between 1 micrometer (“μm”) and 5 millimeter (“mm”) and up to 5 centimeter (“cm”). The coating exhibits resilience of at least 0.25 MPa and up to 25 MPa and an elastic strain limit of at least 0.75% and up to 2.00%.

In another embodiment, the fishing tackle includes a graphite/metal composite shaft, tube, or the like incorporating a metallic coating representing at least 0.5%, such as more than 10% or more than 20%, and up to 75%, 85%, or 95% of a total weight on a polymer substrate optionally containing graphite/carbon fibers. A torsional or in-line stiffness per unit weight of the fishing tackle containing the metallic coating is improved by at least about 5% when compared to a torsional stiffness of a similar fishing tackle not containing the metallic coating.

In another embodiment, the fishing tackle includes a thermoplastic substrate or the like incorporating a metallic coating representing at least 0.05%, such as more than 10% or more than 20%, and up to 75%, 85%, or 95% of a total weight on a polymer substrate optionally containing any number of thermoplastic polymer substrates. A torsional or in-line stiffness per unit weight of the fishing tackle containing the metallic coating is improved by at least about 5% when compared to a torsional stiffness of a similar fishing tackle not containing the metallic coating.

In another embodiment, the fishing tackle includes a portion that includes a first layer and a second layer adjacent to the first layer. At least one of the first layer and the second layer includes a nanostructured material that has a grain size in the submicron range, such as in the nanometer range. Nanostructured materials can be formed as high-strength coating of pure metals, alloys of metals selected from the group of Ag, Au, Co, Cu, Cr, Fe, Ni, Sn, Fe, Pt and Zn and alloying elements selected from the group of Mo, W, B, C, P, S, and Si, and metal matrix composites of pure metals or alloys with particulate additives, such as powders, fibers, nanotubes, flakes, metal powders, metal alloy powders, and metal oxide powders of Al, Co, Cu, In, Mg, Ni, Si, Sn, V, and Zn; nitrides of Al, B and Si; C (e.g., graphite, diamond, nanotubes, Buckminster Fullerenes); carbides of B, Cr, Bi, Si, Ti, V, Zr, Mo, Cr, Ni, Co, Nb and W; borides of Ti, V, Zr, W, Si, Mo, Nb, Cr, and Fe; and self-lubricating materials such as MoS₂ or organic materials such as PTFE. An improved process can be employed to create high strength, equiaxed coatings on metallic components or on non-conductive components that have been metallized to render them suitable for electro-plating. In an alternative embodiment, the process can be used to electroform a stand-alone article on a mandrel or other suitable substrate and, after reaching a desired plating thickness, to remove the free-standing electro-formed article from the temporary substrate.

In another aspect, the invention relates to an improved process for producing fishing tackle. In one embodiment, the process includes: (a) positioning a metallic or metallized work piece or a reusable mandrel/temporary substrate to be plated in a plating tank containing a suitable electrolyte; (b) providing electrical connections to the work piece and to one or several anodes; and (c) forming and electrodepositing a metallic material with an average grain size of less than 1,000 nanometer (“nm”) on at least part of the surface of the work piece using a suitable DC or pulse electro-deposition process, such as described in PCT Publication No. WO 2004/001100 A1.

In the process of an embodiment of the invention, an electro-deposited metallic coatings optionally contains at least 2.5% by volume particulate, such as at least 5%, and up to 75% by volume particulate. The particulate can be selected from the group of metal powders, metal alloy powders, and metal oxide powders of Al, Co, Cu, In, Mg, Ni, Si, Sn, V, and Zn; nitrides of Al, B and Si; C (e.g., graphite or diamond carbides of B, Cr, Bi, Si, Ti, V, Zr, Mo, Cr, Ni, Co, Nb and W; borides of Ti, V, Zr, W, Si, Mo, Nb, Cr, and Fe; MoS₂; and organic materials such as PTFE and other polymeric materials. The particulate average particle size is typically below 10,000 nm (or 10 μcm), such as below 5,000 nm (or 5 μm), below 1,000 nm (or 1 μm), or below 500 nm.

According to an embodiment of the invention, patches, sleeves or structural shells of nanostructured materials, which need not be uniform in thickness, can be electro-deposited in order to form a thicker structural shell on selected sections or sections particularly prone to heavy use or impact. The selected sections can be the tip end of a fishing pole, along the butt or middle section of a fishing pole that may bang against the side of a boat or railing, along the outside of a reel body that may be subject to impact forces that might otherwise produce scratches and denting and the like.

In one embodiment, a substrate or core, such as an aluminum core, may be completely encapsulated by nanostructured material including nanostructured metals. The encapsulation increases the stiffness of the structure, and prevents the possibility of galvanic corrosion of the aluminum alloy core.

In some embodiments, a substrate or core, such as an aluminum alloy core, need not be encapsulated symmetrically. The location of the core can be chosen depending on the particular application. The encapsulation along the perimeter can be controlled during the deposition process or could be later machined to the design requirement. In some exemplary embodiments the encapsulation width can vary from 0.01 mm to 1.0 mm.

In some embodiments, fishing tackle, including fishing rods may be coated in whole or part with a nanostructured material. In one exemplary embodiment, a nanostructured material may be applied to approximately the top twelve inches (12″) of a fishing rod, adjacent to the tip, improving tip durability and tip action felt by the fisherman. In another exemplary embodiment, a nanostructured material may be applied to the middle section of a rod. In yet another exemplary embodiment, a nanostructured material may be applied to the entire length of a rod.

In some embodiments, a nanostructured material may be applied to a fishing reel. In one exemplary embodiment, parts of a fishing reel may be coated with a nanostructured material. The addition of the nanostructured material to the outside of the reel substrate increases the stiffness of the overall reel compared to that of a reel machined from an aluminum alloy, such as 6000-series aluminum alloy. In another exemplary embodiment, an entire reel may be coated with a nanostructured material to provide corrosion resistance.

In some embodiments, a nanostructured material may be applied to a fishing rod guide. In one exemplary embodiment, portions of a guide may be coated with a nanostructured material in order to improve the stiffness, lubricity and corrosion resistance. In another exemplary embodiment, the entire guide may be coated with a nanostructured material.

In accordance with one aspect, a fishing tackle comprises a rod, at least one guide attached to the rod, and a reel operably connected to the rod. At least a portion of one of the rod, the at least one guide and the reel is one of externally and internally coated with nanostructured material.

In accordance with another aspect, a fishing tackle comprises an elongated rod including a first end section, a second end section and a surface extending longitudinally between the first and second end sections. The surface is at least partially electro-deposited with a nanostructured material. The nanostructured material has a predetermined thickness for selectively improving action, power, and casting distance of the elongated rod.

In accordance with yet another aspect, a fishing tackle comprises a rod and at least one guide attached to the rod. The at least one guide is at least partially electro-deposited with a nanostructured material. The nanostructured material has a predetermined thickness for selectively improving friction, stiffness, and corrosion resistance of the at least one guide.

In accordance with still yet another aspect, a fishing tackle comprises a reel including a reel body. At least a portion of the reel body is electro-deposited with a nanostructured material. The nanostructured material improves stiffness, torsional defection, corrosion resistance, weight, and casting distance of the reel.

In accordance with still yet another aspect, a method of manufacturing a fishing tackle comprises providing at least one of an elongated rod including a rod body, a reel including a reel body and a guide including a guide body. At least a portion of at least one of the rod body, the reel body and the guide body is formed as a substrate. The substrate is coated, at least in part, with a nanostructure material.

Other aspects and embodiments of the invention are also contemplated. For example, another aspect of the invention relates to a method of forming fishing tackle including a nanostructured material coating. The foregoing summary and the following detailed description are not meant to restrict the invention to any particular embodiment, but are merely meant to describe some embodiments of the invention.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates a cross-sectional schematic view of a portion of fishing tackle, according to an embodiment of the invention, with nanostructured material providing a structural shell or coating.

FIG. 2 illustrates a cross-sectional schematic view of a portion of fishing tackle, according to another embodiment of the invention, with a nanostructured material in a sandwich construction.

FIG. 3 illustrates a cross-sectional schematic view of a portion of fishing tackle, according to another embodiment of the invention, with a nanostructured material in a sandwich construction with different nanostructured materials on the top and bottom.

FIG. 4 illustrates a cross-sectional schematic view of a portion of fishing tackle, according to another embodiment of the invention, with a nanostructured material providing a structural shell or coating over an Al, polymer or Mg substrate or core.

FIG. 5 illustrates a cross-sectional schematic view of a portion of fishing tackle, according to another embodiment of the invention, with a nanostructured material in a sandwich construction on the top and bottom and Al, polymer or Mg as the substrate or core.

FIG. 6 illustrates a cross-sectional schematic view of a portion of fishing tackle, according to another embodiment of the invention, with a nanostructured material in a sandwich construction with different nanostructured materials on the top and bottom and Al, polymer or Mg as the substrate or core.

FIG. 7 illustrates a cross-sectional schematic view of a portion of fishing tackle, according to another embodiment of the invention, with nanostructured materials fully encapsulating an Al, polymer or Mg substrate or core.

FIG. 8 illustrates mechanical characteristics of a hybrid fishing tackle.

FIGS. 9a-9d illustrate schematic views of fishing rod designs with electro-deposited nanostructured material along different sections of the rod to change the properties.

FIG. 10 illustrates a schematic view of a fishing rod design with electro-deposited nanostructured material along an end section of the rod. The nanostructured material is distributed in a non-uniform thickness in order to improve the action of the rod.

FIG. 11 illustrates fishing rods with electro-deposited nanostructured material along different sections of the rod to change the properties.

FIG. 12 illustrates fishing rods with electro-deposited nanostructured material along the tip of the rod to change the properties.

FIG. 13 is a cross-sectional view of a guide of the fishing rod of FIG. 12 taken generally along lines 13-13 of FIG. 12.

### DETAILED DESCRIPTION

Overview

Embodiments of the invention relate generally to fishing tackle. Fishing tackle in accordance with various embodiments of the invention can be formed using inserts and nanostructured materials having a number of desirable characteristics. In particular, the nanostructured materials can exhibit characteristics such as high strength, high strength-to-weight ratio, high resilience, high fracture toughness, high elasticity, low or high vibration damping depending on the design, high hardness, high ductility, high wear resistance, high corrosion resistance, and low friction. In such manner, the fishing tackle can have improved performance characteristics while being formed in a cost-effective manner. Examples of the fishing tackle include a variety of sports equipment and associated components, such as fishing reels, fishing reel bodies, bass fishing poles, salt water fishing rods, fly fishing rods, multi-segment fishing rods, and other fishing equipment.

### DEFINITIONS

The following definitions apply to some of the features described with respect to some embodiments of the invention. It should be appreciated that these definitions are not limiting and can be expanded upon herein.

As used herein, the singular terms “a,” “an,” and “the” include plural referents unless the context clearly dictates otherwise. Thus, for example, a reference to an object can include multiple objects unless the context clearly dictates otherwise.

As used herein, the term “set” refers to a collection of one or more items. Thus, for example, a set of objects can include a single object or multiple objects. Items included in a set can also be referred to as members of the set. Items included in a set can be the same or different. In some instances, items included in a set can share one or more common characteristics.

As used herein, the term “adjacent” refers to being near or adjoining. Objects that are adjacent can be spaced apart from one another or can be in actual or direct contact with one another. In some instances, objects that are adjacent can be coupled to one another or can be formed integrally with one another.

As used herein, the terms “integral” and “integrally” refer to a non-discrete portion of an object. Thus, for example, a fishing tackle including a fishing pole and a guide that is formed integrally with the fishing pole can refer to an implementation of the fishing tackle in which the fishing pole and the guide are formed as a monolithic unit. An integrally formed portion of an object can differ from one that is coupled to the object, since the integrally formed portion of the object typically does not form an interface with a remaining portion of the object.

As used herein, the term “submicron range” refers to a range of dimensions less than about 1,000 nm, such as from about 2 nm to about 900 nm, from about 2 nm to about 750 nm, from about 2 nm to about 500 nm, from about 2 nm to about 300 nm, from about 2 nm to about 100 nm, from about 10 nm to about 50 nm, or from about 10 nm to about 25 nm.

As used herein, the term “nanometer range” or “nm range” refers to a range of dimensions from about 1 nm to about 100 nm, such as from about 2 nm to about 100 nm, from about 10 nm to about 50 nm, or from about 10 nm to about 25 nm.

As used herein, the term “size” refers to a characteristic dimension of an object. Thus, for example, a size of an object that is a spherical can refer to a diameter of the object. In the case of an object that is non-spherical, a size of the object can refer to an average of various dimensions of the object. Thus, for example, a size of an object that is a spheroidal can refer to an average of a major axis and a minor axis of the object. When referring to a set of objects as having a specific size, it is contemplated that the objects can have a distribution of sizes around the specific size. Thus, as used herein, a size of a set of objects can refer to a typical size of a distribution of sizes, such as an average size, a median size, or a peak size.

As used herein, the term “grain size” refers to a size of a set of constituents or components included in a material, such as a nanostructured material. When referring to a material as being “fine-grained,” it is contemplated that the material can have an average grain size in the submicron range, such as in the nm range.

As used herein, the term “microstructure” refers to a microscopic configuration of a material. An example of a microstructure is one that is quasi-isotropic in which a set of crystals are relatively uniform in shape and size and exhibit a relatively uniform grain boundary orientation. Another example of a microstructure is one that is anisotropic in which a set of crystals exhibit relatively large deviations in terms of shape, size, grain boundary orientation, texture, or a combination thereof.

Nanostructured Materials

Certain embodiments of the invention relate to nanostructured materials that can be used for sports applications. A microstructure and resulting characteristics of nanostructured materials can be engineered to meet performance criteria for a variety of fishing tackle. In some instances, engineering of nanostructured materials can involve enhancing or optimizing a set of characteristics, such as strength, strength-to-weight ratio, resilience, fracture toughness, vibration damping, hardness, ductility, and wear resistance. In other instances, engineering of nanostructured materials can involve trade-offs between different characteristics.

According to some embodiments of the invention, a nanostructured material has a relatively high density of grain boundaries as compared with other types of materials. This high density of grain boundaries can translate into a relatively large percentage of atoms that are adjacent to grain boundaries. In some instances, up to about 50 percent or more of the atoms can be adjacent to grain boundaries. Without wishing to be bound by a particular theory, it is believed that this high density of grain boundaries promotes a number of desirable characteristics in accordance with the Hall-Petch Effect. In order to achieve this high density of grain boundaries, the nanostructured material is typically formed with a relatively small grain size. Thus, for example, the nanostructured material can be formed with a grain size in the submicron range, such as in the nm range. As the grain size is reduced, a number of characteristics of the nanostructured material can be enhanced. For example, in the case of nickel, its hardness can increase from about 140 Vickers for a grain size greater than about 5 μm to about 300 Vickers for a grain size of about 100 nm and ultimately to about 600 Vickers for a grain size of about 10 nm. Similarly, ultimate tensile strength of nickel can increase from about 400 MPa for a grain size greater than about 5 μm to 670 MPa for a grain size of about 100 nm and ultimately to over 900 MPa for a grain size of about 10 nm.

According to some embodiments of the invention, a nanostructured material includes a set of crystals that have a size in the nm range and, thus, can be referred to as a nanostructured material. However, as described herein, nanostructured materials having desirable characteristics can also be formed with larger grain sizes, such as in the submicron range. A microstructure of the nanostructured material can be engineered to cover a wide range of microstructure types, including one that is quasi-isotropic, one that is slightly-anisotropic, and one that is anisotropic and highly textured. Within this range of microstructure types, a reduction in size of the set of crystals can be used to promote a number of desirable characteristics.

Particularly useful nanostructured materials include those that exhibit a set of desirable characteristics, such as high strength, high strength-to-weight ratio, high resilience (e.g., defined as R=σ²/2E), high fracture toughness, high elasticity, high vibration damping, high hardness, high ductility, high wear resistance, and low friction. For example, in terms of strength, particularly useful nanostructured materials include those having a yield strength that is at least about 200 MPa, such as at least about 500 MPa, at least about 1,000 MPa, or at least about 1,500 MPa, and up to about 2,750 MPa, such as up to about 2,500 MPa. In terms of resilience, particularly useful nanostructured materials include those having a modulus of resilience that is at least about 0.15 MPa, such as at least about 1 MPa, at least about 2 MPa, at least about 5 MPa, or at least about 7 MPa, and up to about 25 MPa, such as up to about 12 MPa. In terms of elasticity, particularly useful nanostructured materials include those having an elastic limit that is at least about 0.75 percent, such as at least about 1 percent or at least about 1.5 percent, and up to about 2 percent. In terms of hardness, particularly useful nanostructured materials include those having a hardness that is at least about 300 Vickers, such as about 400 Vickers, or at least about 500 Vickers, and up to about 2,000 Vickers, such as up to about 1,000 Vickers, up to about 800 Vickers, or up to about 600 Vickers. In terms of ductility, particularly useful nanostructured materials include those having a tensile strain-to-failure that is at least about 1 percent, such as at least about 3 percent or at least about 5 percent, and up to about 15 percent, such as up to about 10 percent or up to about 7 percent.

Nanostructured materials according to various embodiments of the invention can be formed of a variety of materials. Particularly useful materials include: (1) metals selected from the group of Ag, Au, Cd, Co, Cr, Cu, Fe, Ir, Ni, Pb, Pd, Pt, Rh, Sn, and Zn; (2) metal alloys formed of these metals; and (3) metal alloys formed of these metals along with an alloying component selected from the group of B, C, Mn, Mo, P, S, Si, and W as described in the patent application of Palumbo et al., U.S. patent application Ser. No. 11/013,456, entitled “Strong, Lightweight Article Containing a Fine-Grained Metallic Layer” and filed on Dec. 17, 2004 and the patent application of Palumbo et al., U.S. patent application Ser. No. 10/516,300 entitled “Process for Electro-plating Metallic and Metal matrix Composite Foils, Coatings and Microcomponents” and filed on Dec. 9, 2004, the disclosures of which are incorporated herein by reference in their entirety.

In some instances, a nanostructured material can be formed as a metal matrix composite in which a metal or a metal alloy forms a matrix within which a set of additives are dispersed. A variety of additives can be used, and the selection of a specific additive can be dependent upon a variety of considerations, such as its ability to facilitate formation of the nanostructured material and its ability to enhance characteristics of the nanostructured material. Particularly useful additives include particulate additives formed of: (1) metals selected from the group of Al, Co, Cu, In, Mg, Ni, Sn, V, and Zn; (2) metal alloys formed of these metals; (3) metal oxides formed of these metals; (4) nitrides of Al, B, and Si; (5) C, such as in the form of graphite, diamond, nanotubes, and Buckminster Fullerenes; (6) carbides of B, Cr, Bi, Si, Ti, V, Zr, Mo, Cr, Ni, Co, Nb and W; borides of Ti, V, Zr, W, Si, Mo, Nb, Cr, and Fe; (7) self-lubricating materials, such as MoS₂; and (8) polymers, such as polytetrafluoroethylene (“PTFE”). During formation of a nanostructured material, a set of particulate additives can be added in the form of powders, fibers, or flakes that have a size in the submicron range, such as in the nm range. Depending on specific characteristics that are desired, the resulting nanostructured material can include an amount of particulate additives that is at least about 2.5 percent by volume, such as at least about 5 percent by volume, and up to about 75 percent by volume.

Table 1 below provides examples of classes of nanostructured materials that can be used to form fishing tackle described herein. Table 1 also sets forth specific characteristics that are particularly enhanced for these classes of nanostructured materials. As used below and subsequently herein, the notation “n-X₁” refers to a nanostructured material formed of material X₁, and the notation “n-X₁X₂” refers to a nanostructured material formed of an alloy of material X₁ and material X₂

TABLE 1

| Nanostructured Materials | Characteristics |
|---|---|
| n-Ni, n-Ni Co, n-Ni Fe | high strength and high fracture |
| | toughness |
| n-Co P, n-Ni P, and n-Co P+ B₄C | high degree of hardness & wear |
| composites | resistance |
| n-Cu and n-Brass | high strength |
| n-Zn, n-Zn Ni, n-Zn Fe | high corrosion resistance |
| Metal Composites: n-Ni + MoS₂ or | low coefficient of friction |
| n-Ni Fe + MoS₂ | |
| Precious Metals & Alloys: n-Ag, | high hardness & made of precious |
| n-Au, n-Pt | metals |

Nanostructured materials can be formed using a variety of manufacturing techniques, such as sputtering, laser ablation, inert gas condensation, oven evaporation, spray conversion pyrolysis, flame hydrolysis, high energy milling, sol gel deposition, and electro-deposition. According to some embodiments of the invention, electro-deposition can be particularly desirable, since this manufacturing technique can be used to form nanostructured materials in a manner that is effective in terms of cost and time. Moreover, by adjusting electro-deposition settings, a microstructure of a nanostructured material can be controlled, thus allowing fine-tuned control and reproducibility of resulting characteristics of the nanostructured material.

The foregoing provides a general overview of some embodiments of the invention.

Fishing Tackle

Implementations of Fishing Tackle

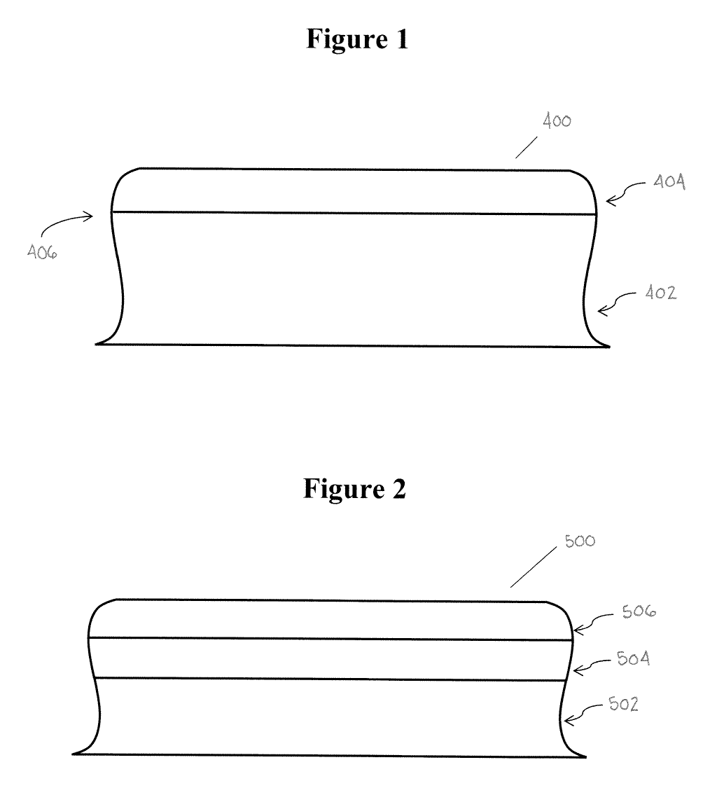

With reference to FIG. 1, a cross-sectional schematic view of a portion 400 of a fishing tackle, according to an embodiment of the invention, is illustrated. The portion 400 is implemented in accordance with a multi-layered design and includes a first layer 402 and a second layer 404 that is adjacent to the first layer 402. The second layer 404 is formed adjacent to the first layer 402 via electro-deposition. However, it is contemplated that the second layer 404 can be formed using any other suitable manufacturing technique.

The first layer 402 is implemented as a substrate and is formed of any suitable material, such as a fibrous material, a foam, a ceramic, a metal, a metal alloy, a polymer, or a composite. Thus, for example, the first layer 402 can be formed of wood; an aluminum alloy, such as a 6000-series aluminum alloy or a 7000-series aluminum alloy; a steel alloy; a scandium alloy; a thermoplastic or thermoset polymer, such as a copolymer of acrylonitrile, butadiene, and styrene; a carbon/epoxy composite, such as a graphite fiber/epoxy composite; a fiberglass/epoxy composite; a poly-paraphenylene terephthalamide fiber/epoxy composite, such as a Kevlar® brand fiber/epoxy composite, where Kevlar® brand fibers are available from DuPont Inc., Wilmington, Del.; or a polyethylene fiber/epoxy composite, such as a Spectra® brand fiber/epoxy composite, where Spectra® brand fibers are available from Honeywell International Inc., Morristown, N.J. The selection of a material forming the first layer 402 can be dependent upon a variety of considerations, such as its ability to facilitate formation of the second layer 404, its ability to be molded or shaped into a desired form, and desired characteristics of the portion 400.

While not illustrated in FIG. 1, it is contemplated that the first layer 402 can be formed so as to include two or more sub-layers, which can be formed of the same material or different materials. For certain implementations, at least one of the sub-layers can be formed of a conductive material, such as in the form of a coating of a metal. As can be appreciated, such implementation of the first layer 402 can be referred to as a “metallized” form of the first layer 402. The conductive material can be deposited using any suitable manufacturing technique, such as metallization in an organic or inorganic bath, aerosol spraying, electroless deposition, chemical vapor deposition, physical vapor deposition, or any other suitable coating or printing technique. Such metallized form can be desirable, since the conductive material can facilitate formation of the second layer 404 as well as provide enhanced durability and strength to the portion 400.

The second layer 404 is implemented as a coating and is formed of a nanostructured material. Thus, for example, the second layer 404 can be formed of n-Ni, n-Ni Co, n-Ni Fe, n-Co P, n-Ni P, n-Cu, n-Zn, n-Zn Ni, n-Zn Fe, n-Ag, n-Au, n-Pt, n-Fe, or a composite thereof, such as a n-Ni+B₄C composite, a n-Ni Fe+MOS₂ composite, or a carbon n-Ni Fe+nanotube composite. The selection of the nanostructured material can be dependent upon a variety of considerations, such as desired characteristics of the portion 400.

During use, the second layer 404 can be positioned so that it is exposed to an outside environment, thus serving as an outer coating. It is also contemplated that the second layer 404 can be positioned so that it is adjacent to an internal compartment, thus serving as an inner coating. Referring to FIG. 1, the second layer 404 at least partly covers a surface 406 of the first layer 402. Depending on characteristics of the first layer 402 or a specific manufacturing technique used, the second layer 404 can extend below the surface 406 and at least partly permeate the first layer 402. While two layers are illustrated in FIG. 1, it is contemplated that the portion 400 can include more or less layers for other implementations. In particular, it is contemplated that the portion 400 can include a third layer (not illustrated in FIG. 1) that is formed of the same or a different nanostructured material. It is also contemplated that the portion 400 can be implemented in accordance with an electro-formed design, such that the first layer 402 serves as a temporary substrate during formation of the second layer 404. Subsequent to the formation of the second layer 404, the first layer 402 can be separated using any suitable manufacturing technique.

Depending upon specific characteristics desired for the portion 400, the second layer 404 can cover from about 1 to about 100 percent of the surface 406 of the first layer 402. Thus, for example, the second layer 404 can cover from about 20 to about 100 percent, from about 50 to about 100 percent, or from about 80 to about 100 percent of the surface 406. When mechanical characteristics of the portion 400 are a controlling consideration, the second layer 404 can cover a larger percentage of the surface 406. On the other hand, when other characteristics of the portion 400 are a controlling consideration, the second layer 404 can cover a smaller percentage of the surface 406. Alternatively, or in conjunction, when balancing mechanical and other characteristics of the portion 400, it can be desirable to adjust a thickness of the second layer 404.

In some instances, the second layer 404 can have a thickness that is in the range from about 10 μm to about 5 cm. Thus, for example, the second layer 404 can have a thickness that is at least about 10 μm, such as at least about 25 μm or at least about 30 μm, and up to about 5 mm, such as up to about 400 μm or up to about 100 μm. In other instances, the second layer 404 can have a thickness to grain size ratio that is in the range from about 6 to about 25,000,000. Thus, for example, the second layer 404 can have a thickness to grain size ratio that is at least about 25, such as at least about 100 or at least about 1,000, and up to about 12,500,000, such as up to about 1,250,000, up to about 100,000, or up to about 10,000. When mechanical characteristics of the portion 400 are a controlling consideration, the second layer 404 can have a greater thickness or a larger thickness to grain size ratio. On the other hand, when other characteristics of the portion 400 are a controlling consideration, the second layer 404 can have a smaller thickness or a smaller thickness to grain size ratio. Alternatively, or in conjunction, when balancing mechanical and other characteristics of the portion 400, it can be desirable to adjust a percentage of the surface 406 that is covered by the second layer 404.

For certain implementations, the second layer 404 can represent from about 1 to about 100 percent of a total weight of the portion 400. Thus, for example, the second layer 404 can represent at least about 3 percent of the total weight, such as at least about 10 percent or at least about 20 percent, and up to about 95 percent of the total weight, such as up to about 85 percent or up to about 75 percent. When mechanical characteristics of the portion 400 are a controlling consideration, the second layer 404 can represent a larger weight percentage of the portion 400. On the other hand, when other characteristics of the portion 400 are a controlling consideration, the second layer 404 can represent a lower weight percentage of the portion 400. Alternatively, or in conjunction, when balancing mechanical and other characteristics of the portion 400, it can be desirable to adjust a thickness of the second layer 404 or a percentage of the surface 406 that is covered by the second layer 404.

In some instances, the second layer 404 can be formed so as to provide substantially uniform characteristics across the surface 406 of the first layer 402. Thus, as illustrated in FIG. 1, the nanostructured material is substantially uniformly distributed across the surface 406. Such uniformity in distribution can serve to reduce or prevent the occurrence of a weak spot at or near a section of the portion 400 that includes a lesser amount of the nanostructured material than another section. However, depending upon specific characteristics desired for the portion 400, the distribution of the nanostructured material can be varied from that illustrated in FIG. 1. Thus, for example, the nanostructured material can be distributed non-linearly across the surface 406 to match a stress profile of the first layer 402 under service loads or meet a set of mass characteristics requirements, such as center of gravity, balance point, inertia, swing weight, or total mass.

During formation of the portion 400, the first layer 402 is positioned in a plating tank that includes a suitable plating solution. It is also contemplated that a plating rack, a plating barrel, a plating brush, or a plating drum can be used in place of, or in conjunction with, the plating tank. In some instances, a set of additives can be added when forming the plating solution. Next, electrical connections are formed between the first layer 402, which serves as a cathode, and at least one anode, and the second layer 404 can be deposited on the surface 406 of the first layer 402 using any suitable electro-deposition technique, such as direct current (“DC”) electro-deposition, pulse electro-deposition, or some other current waveform electro-deposition. Thus, for example, the second layer 404 can be deposited by transmitting a set of direct current cathodic-current pulses between the anode and the cathode and by transmitting a set of direct current anodic-current pulses between the cathode and the anode. After the second layer 404 is formed on the surface 406, the second layer 404 can be further strengthened by applying a suitable heat treatment.

With reference to FIG. 2, a cross-sectional schematic view of a portion 500 of a fishing tackle, according to another embodiment of the invention is illustrated. The portion 500 is implemented in accordance with a multi-layered design and includes a first layer 502, a second layer 504 that is adjacent to the first layer 502, and a third layer 506 that is adjacent to the second layer 504. In particular, the portion 500 includes a laminate structure that is formed via a lay-up of the layers 502, 504, and 506, and at least one of the layers 502, 504, and 506 is formed of a nanostructured material. While three layers are illustrated in FIG. 2, it is contemplated that the portion 500 can include more or less layers for other implementations.

The first layer 502 and the third layer 506 are formed of any suitable materials, such as fibrous materials, foams, ceramics, metals, metal alloys, polymers, or composites. Thus, for example, at least one of the first layer 502 and the third layer 506 can be formed of a graphite fiber/epoxy composite. As can be appreciated, a graphite fiber/epoxy composite can have any of a variety of forms, such as uniaxial, biaxial, woven, pre-impregnated, filament wound, tape-layered, or a combination thereof. The selection of materials forming the first layer 502 and the third layer 506 can be dependent upon a variety of considerations, such as their ability to facilitate formation of the second layer 504, their ability to be molded or shaped into a desired form, and desired characteristics of the portion 500.

The second layer 504 is formed of a nanostructured material, such as n-Ni, n-Ni Co, n-Ni Fe, n-Co P, n-Ni P, n-Cu, n-Zn, n-Zn Ni, n-Zn Fe, n-Ag, n-Au, n-Pt, n-Fe, or a composite thereof. The selection of the nanostructured material can be dependent upon a variety of considerations, such as its ability to be molded or shaped into a desired form and desired characteristics of the portion 500. In the illustrated embodiment, the second layer 504 is formed as a foil, a sheet, or a plate via electro-deposition. In particular, the second layer 504 is deposited on a temporary substrate using similar electro-deposition settings as previously described with reference to FIG. 1. It is also contemplated that the second layer 504 can be formed using any other suitable manufacturing technique. The resulting second layer 504 formed of the nanostructured material can have characteristics that are similar to those previously described with reference to FIG. 1.

During formation of the portion 500, the first layer 502 serves as an inner ply to which the second layer 504 and the third layer 506 are sequentially added as a middle ply and an outer ply, respectively. Once properly positioned with respect to one another, the layers 502, 504, and 506 are coupled to one another using any suitable fastening mechanism, such as through inter-laminar shear strength of epoxy, an additional chemical adhesive paste, or an adhesive thin film added before a standard cure cycle that can optionally involve vacuum pressure. The portion 500 can be formed with a variety of shapes using hand lay-up, tape-layering, filament winding, bladder molding, or any other suitable manufacturing technique.

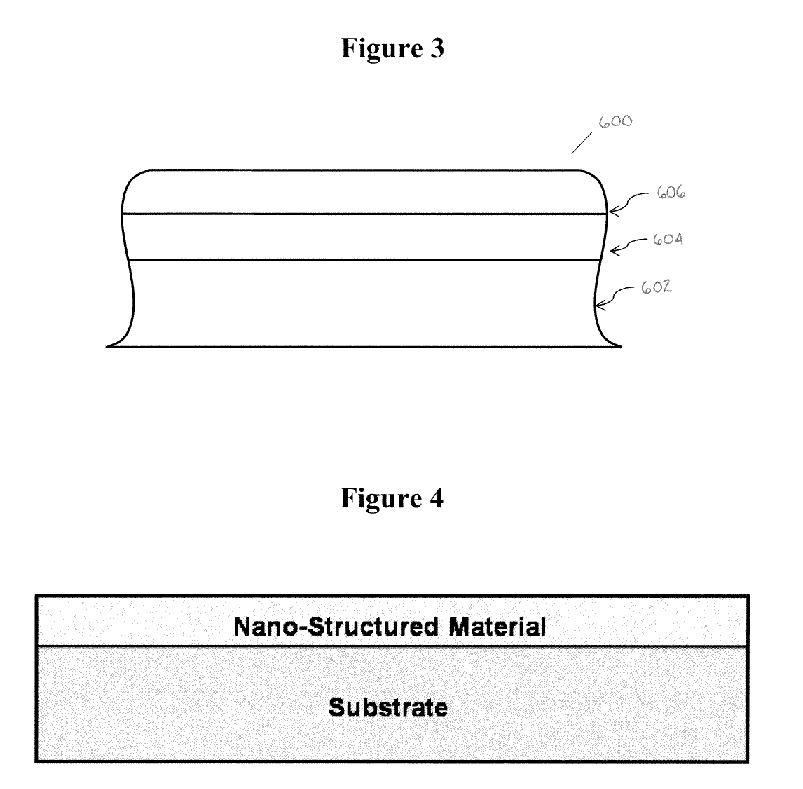

With reference to FIG. 3, a cross-sectional schematic view of a portion 600 of a fishing tackle, according to a further embodiment of the invention is illustrated. The portion 600 is implemented in accordance with a multi-layered design and includes a first layer 602, a second layer 604 that is adjacent to the first layer 602, and a third layer 606 that is adjacent to the second layer 604. In particular, the portion 600 includes a laminate structure that is formed via a lay-up of the layers 602, 604, and 606, and at least one of the layers 602, 604, and 606 is formed of a nanostructured material. While three layers are illustrated in FIG. 3, it is contemplated that the portion 600 can include more or less layers for other implementations.

The first layer 602 and the third layer 606 are formed of the same nanostructured material or different nanostructured materials. The selection of the nanostructured materials can be dependent upon a variety of considerations, such as their ability to be molded or shaped into a desired form and desired characteristics of the portion 600. In the illustrated embodiment, the first layer 602 and the third layer 606 are formed as foils, sheets, or plates using similar electro-deposition settings as previously described with reference to FIG. 1. It is also contemplated that the layers 602 and 606 can be formed using any other suitable manufacturing technique. The resulting layers 602 and 606 can have characteristics that are similar to those previously described with reference to FIG. 1.

The second layer 604 is formed of a visco-elastic material that exhibits high vibration damping. The selection of the visco-elastic material can be dependent upon a variety of other considerations, such as its ability to be molded or shaped into a desired form. An example of the visco-elastic material is a visco-elastic polymer that is based on polyether and polyurethane, such as Sorbothane® brand polymers that are available from Sorbothane, Inc., Kent, Ohio. Advantageously, the use of the visco-elastic material allows the second layer 604 to serve as a constrained, vibration damping layer, thus reducing vibrations and providing a desired feel while fishing.

During formation of the portion 600, the first layer 602 serves as an inner ply to which the second layer 604 and the third layer 606 are sequentially added as a middle ply and an outer ply, respectively. Once properly positioned with respect to one another, the layers 602, 604, and 606 are coupled to one another using any suitable fastening mechanism, such as though inter-laminar shear strength of epoxy, an additional chemical adhesive paste, or an adhesive thin film added before a standard cure cycle that can optionally involve vacuum pressure. The portion 600 can be formed with a variety of shapes using hand lay-up, tape-layering, filament winding, bladder molding, or any other suitable manufacturing technique.

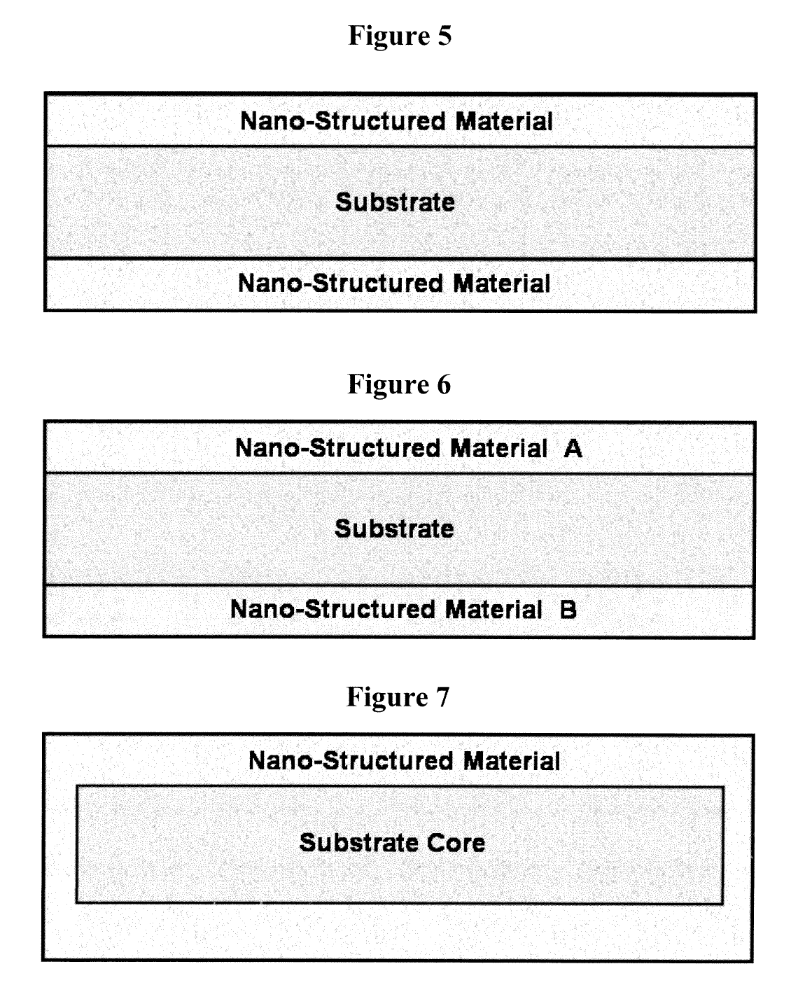

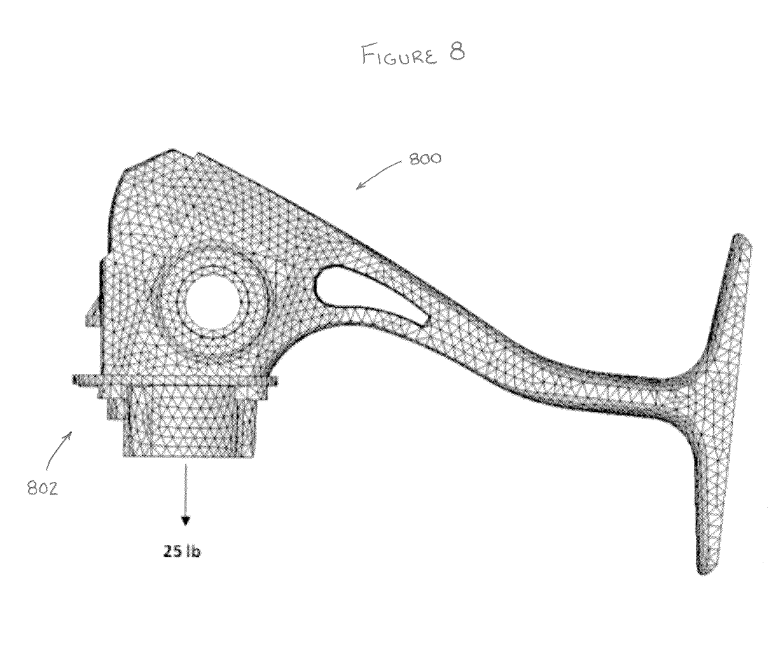

With reference to FIGS. 4-7, cross-sectional schematic views of a portion of a fishing tackle, according to embodiments of the invention which are similar to the those described above with respect to FIGS. 1-3, are illustrated. FIG. 4 illustrates a fishing tackle with a nanostructured material and a substrate. FIG. 5 illustrates a fishing tackle with a nanostructured material in a sandwich construction and a substrate. FIG. 6 illustrates a fishing tackle with a nanostructured material in a sandwich construction with different nanostructured materials and a substrate. FIG. 7 illustrates a fishing tackle with nanostructured materials fully encapsulating a substrate. It should be appreciated that both the nanostructured material and substrate shown in FIGS. 4-7 can have a variable thickness.

### EXAMPLES

The following examples describe specific features of some embodiments of the invention to illustrate and provide a description for those of ordinary skill in the art. The examples should not be construed as limiting the invention, as the examples merely provide specific methodology useful in understanding and practicing some embodiments of the invention.

### Example 1

### Mechanical Characteristics of Hybrid Fishing Reels

A polymer fishing reel was molded out of specified, carbon filled polyamide that is amenable to nano activation and fusing. The surface of the polyamide reel was activated to make the surface amenable for electrodeposition. The activated fishing reel was connected to an electrical circuit and nano nickel was deposited to a thickness of about 50 microns. As shown in FIG. 8, a base 802 of the hybrid reel 800 was fixed in a horizontal manner and a 25 lb weight was hung from the reel. The deflection due to the application of the 25 lb weight was measured. The hybrid nanometal reel deflected 4.25 mm, while the polymer reel deflected 7.5 mm. The polymer reel deflected 76% more than the nano reel.

### Example 2

### Hybrid Fishing Reel is Able to Replace al Fishing Reel at Same Deflection, But Lower Weight

Empirical results from Example 1 were used to develop an analytical model of the deflection of the fishing reel under load. The empirical results matched the analytical model. The model was then used to determine the amount of deflection for an aluminum reel and compared to a hybrid nano reel. The results can be seen in the table below. With the addition of 300 microns of nanostructured nickel alloy, the hybrid reel deflects 0.667 mm, while the Al reel deflects 0.692 mm. Additionally, the hybrid reel weighs 26% less.

| | | | | | On Axis Load Deflection | | | |
|---|---|---|---|---|---|---|---|---|
| | Modulus | Strength | Density | Weight | (mm) | | | |
| Materials | (Gpa) | (Mpa) | (g/cc) | (g) | 10 lb | 20 lb | 40 lb | 60 lb |
| Hybrid Reel | 15 | 289 | 1.6 | 33.15 | 3.192 | 6.338 | 12.44 | 18.19 |
| Die Cast Al | 70 | 165 (YS) | 2.63 | 54.49 | 0.681 | 1.362 | 2.756 | 4.635 |
| Al 6061 T6 | 68.9 | 276 (YS) | 2.7 | 55.94 | 0.692 | 1.384 | 2.764 | 4.141 |
| DuPont 23G + Partial | 23/162 | 450/1146 | 1.6/8.7 | 39.96 | 0.753 | 1.514 | 3.02 | 4.516 |
| Fusing | | (YS) | | | | | | |
| 250 um HS-91 | | | | | | | | |
| DuPont 23G + Partial | 23/162 | 450/1146 | 1.6/8.7 | 41.32 | 0.667 | 1.343 | 2.681 | 4.010 |
| 300 um | | | | | | | | |
| HS-91 | | | | | | | | |

### Example 3

### Improvement of the impact performance of a Fishing Rod

The tip of a composite bass fishing rod was coated with nanostructured metal at a thickness of 65 microns, this rod being referred to as “nanorod” henceforth. It was then segmented into 2 inch segments. A composite rod without the nanostructured metal was used as a control sample. It was cut into 1 inch segments in the same manner as the nanorod. One segment at a time was laid flat between two parallel plates and crushed. The force required for the initial failure of the segment was recorded. This testing was completed for all segments of the nanorod and the control composite rod. The results are tabulated below. The nanorod resisted the force to a much higher level than the control composite rod. The segment that was at 5 cm from the tip of the rod for the nanorod failed at 98 MPa, whereas the composite rod without nano failed at 24 MPa.

### Example 4

### Fishing Rods Formed Via a Nanostructured Nickel Electro-Deposit Along Graphite/Epoxy FRP in Such a Way to Create a More Dynamic Performing Fishing Rod

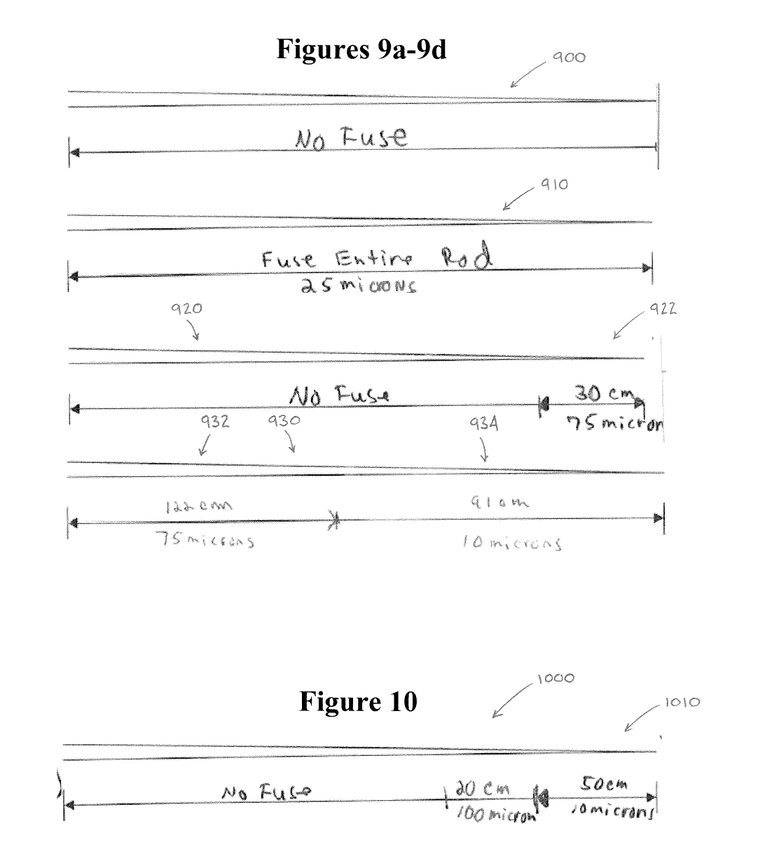

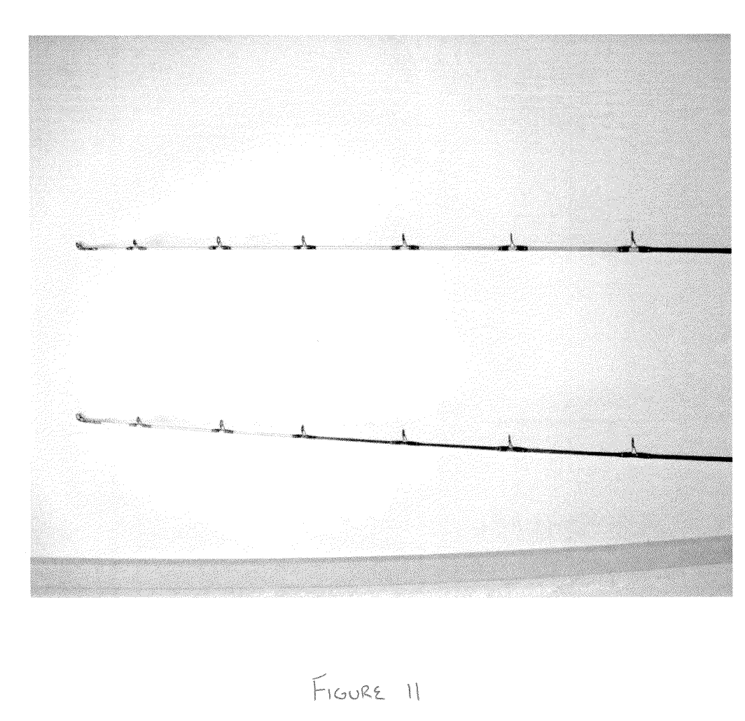

As shown in FIGS. 9a-9d and 10, various fishing rods were designed with nanostructured material applied in such a way as to increase several key aspects of the performance of each fishing rod. These key aspects generally are casting distance, casting accuracy, tip action, sensitivity and power. By adding nanostructured material at different thickness and positions, the aspects of the fishing rod can be modified. It should be appreciated that the thickness of nanostructured material and positioning of the applied nanostructure material denoted in FIGS. 9a-9d and 10 is by way of example only, and that alternative thicknesses and positions for each illustrated design are contemplated. Further, it should be appreciated that each fishing rod can be a unitary member or comprised of at least two separate connected members.

FIG. 9a schematically illustrates a fishing rod 900 having no nanostructured material applied or fused thereto. FIG. 9b schematically illustrates a fishing rod 910 with nanostructured material applied along its entire longitudinal extent. The nanostructured material can have a thickness of about 25 microns. FIG. 9c schematically illustrates a fishing rod 920 with nanostructured material applied along approximately the first 30 cm of an end section 922. The nanostructured material can have a thickness of about 75 microns. FIG. 9d schematically illustrates a fishing rod 930 having a first section 932 and a second section 934. Nanostructured material having a thickness of about 75 microns is applied along approximately the first 122 cm of the first section 932. Nanostructured material having a thickness of about 10 microns is applied along approximately the first 91 cm of the second section 934. FIG. 10 schematically illustrates “fishing rod #7”. This rod 1000 is designed to increase the action of the rod by varying the thickness of the nanostructured material at approximately 50 cm measured from a first end or tip 1010 of the rod.

Tests were performed by local fishing professionals and an objective rating was made in a blind study by these fishermen. The above designs were tested by the fishermen, but a specific design lent itself to a higher performing rod. Particularly, fishing rod #7 was designed in such a way that the action was sped up, the casting distance was increased, and the “fish on” power was improved. The action was improved by changing the coating thickness at a point nearer the tip 1010 of the rod 1000, making it a faster action rod. Between about 50 cm and about 100 cm, the coating thickness was increased from about 10 microns to about 100 microns which did not affect the tip action, but did improve the “fish on” power and casting distance.

Bass Rod Test
Test Results
(Rating 1-10, 10 = Best)

| Category | Fishing Rod #7 | Control Rod |
|---|---|---|
| Casting Distance | 8.1 | 5 |
| Casting Accuracy | 7.7 | 5 |
| Tip Action | 8.3 | 5 |
| Sensitivity | 8.1 | 5 |
| “Fish On” Power | 7.3 | 5 |
| Aesthetics | 5.1 | 5 |

### Example 5

### Demonstration of the Corrosion Resistance of Nanometal for a Fishing Reel

### Relative to Al

A plate was coated with copper and then plated over with nano nickel having 0.002 inch thickness. The plate was then subjected to a 5% sodium chloride salt spray test per ASTM B117 specification and evaluated under ASTM D610 and ASTM D1654. After 1000 hours the adhesion creep back received a 10 rating and the unscribed rating received a nine (9). There was no creep back from the scribe line and no red rust was seen. There was a very slight copper green from the scribe line

Fishing Tackle Applications

According to an embodiment of the invention, patches, sleeves or sections of nanostructured materials can be electro-deposited on selected areas, such as on fishing rods, fishing reel bodies or fishing rod guides, without the need to cover an entire article. In addition, patches, sleeves or sections of nanostructured materials, which need not be uniform in thickness, can be electro-deposited in order to, for example, form a thicker coating on selected sections or sections particularly prone to heavy use, bending, and impact.

Another aspect of the invention relates to a nanostructured material layer performing as the impact surface. A nanostructured layer with higher hardness will wear significantly less and show greater resistance to impact damage, cracking, cuts, nicks and abrasion, as compared to common materials used in fishing tackle manufacture such as FRP composites. Thus the performance will be maintained throughout the product life due to the presence of the nanostructured material as a protective layer or impact surface. This is particularly important when considering the abrasion that results from dirt or other particles carried by fresh or marine water thru and on the fishing tackle during normal use including the guides, the rod sections, and on the reel bodies themselves.

In one embodiment a bi-metallic fishing reel body having a sandwich or layered construction, where one component of the sandwich is a nanostructured material as shown in FIG. 1 thru 6 inclusive, may be used to improve the performance and durability of the reel. The improved performance is achieved through increased stiffness in the reel body, improved long term durability of the reel body with a wear resistant impact surface, and better feel due to low vibration caused by the attenuation of multilayered design.

In one embodiment an aluminum alloy, polymeric or magnesium alloy substrate or core may be partially or completely encapsulated by nanostructured material. The encapsulation increases the stiffness and strength of the structure. In addition, complete encapsulation prevents the possibility of galvanic corrosion of the aluminum alloy or magnesium alloy core and it prevents hygroscopic material from absorbing moisture. In the case of Polyamides this can eliminate the 50% reduction in flexural properties as seen when the polymer is exposed to moisture. Illustrations of the cross-sections of several prototype embodiments are shown in FIGS. 4, 5, and 6. An illustration of a cross section of one embodiment of complete encapsulation is shown in FIG. 7.

In some embodiments the aluminum, polymer or magnesium alloy substrate or core need not be encapsulated symmetrically. The location of the core in the insert can be chosen depending on the particular application. The encapsulation width along the perimeter, i.e. the material covering the perimeter of the aluminum alloy core, can be controlled during the electro-deposition process and could be later machined to the design requirement. In some exemplary embodiments the encapsulation width or thickness can vary from 0 to 1 mm or more.

In one embodiment, in order to make a bi-metallic sandwich, one would begin with a substrate or core of the sandwich structure which may be an aluminum alloy. The core can be any aluminum alloy including the 1XXX pure Al, 2XXX Al—Cu, 3XXX Al—Mn, 4XXX Al—Si, 5XXX Al—Mg, 6XXX Al—Mg—Si, 7XXX Al—Zn, 8XXX series, Al—Li alloys or Sc-containing Al alloys. It is preferred that the aluminum alloy chosen is in its highest strength temper to make it an effective core. For the heat treatable alloys such as the 7XXX, 6XXX and the 2XXX series it is usually the T6 temper that is the highest strength. For non heat-treatable alloys such as 5XXX, the core material should be used in the H temper for the highest strength.

Prior to nanostructured material deposition, the core may be subjected to an activation process. This process prepares the aluminum, polymer or magnesium alloy surface to be more amenable for adhesion to the electro-deposited nanostructured material. The activation process may consist of a series of steps aimed at removing the oxide surface on aluminum alloys or magnesium alloys (creation of a surface roughness for the polymers). Processes such as this are well-established and practiced commercially by companies such as MacDermid or Rohm &Haas. A final step of the activation process can be a copper strike to promote a smoother surface and provide a conductive and readily electro-platable surface. In this final step a thin layer of copper is deposited using standard electrochemical methods. One example of such a copper strike is the “acid copper.”

Fishing tackle components, such as reel bodies or guides can be fabricated either individually or as in large plates or shells with the product cut out using any suitable method. Whether we start with an individual aluminum, magnesium, or polymer substrate or a sheet of said materials, the substrate may be first subjected to an activation process. Next, the activated core may be placed in an electro-chemical cell and the nanostructured material deposited selectively in strategic areas to improve performance such as localized stiffness or impact resistance using the electro-deposition process described in previous examples. The process may be run until the required thickness of deposited material has been reached. Under controlled process conditions, equal amounts of material can deposited on each side of the substrate, as shown schematically in FIG. 5.

In another embodiment of the invention, the nanostructured material may only be electro-deposited on one side as shown in FIG. 1. In this case, one side of the substrate may be masked off and made electrically non-conductive. This can be achieved by wrapping a tape, painting with a lacquer, or any other suitable method. The electro-deposition process is then run until the required thickness of the nanostructured material layer is achieved

In some embodiments different amounts of nanostructured material electro-deposition may be required. If the design of the fishing tackle or reel body, for example, requires that different amounts of nanostructured material to be deposited on the two sides of the substrate, then the following modifications to the process may be done.

In one embodiment, the nanostructured material is deposited on one side of the substrate to begin with, the other side being masked off with electrically non-conducting material. The process is run for a sufficient length of time to allow the required build up of the nanostructured material. Next, the mask may be removed and applied to the side on which nanostructured material is previously deposited. The substrate is run again for the time necessary to achieve different deposition thickness.

In another embodiment of the invention, the nanostructured material is deposited on both sides of the substrate simultaneously by placing a separate anode on each side. The thickness on each side can be controlled by applying different currents to different sides of the substrate.

In another embodiment, the nanostructured material is deposited on both sides of the substrate using two separate circuits as described before. The fabrication process begins with deposition from both sides. After the required thickness for one side is reached, that circuit is interrupted and a shield is dropped very close to the nanostructured metal surface to prevent any further deposition on that side.

In another embodiment, the electro-deposition process is carried out in two stages. In the first stage a nanostructured material having composition A is deposited. In the second stage of the process, nanostructured material having composition B is deposited. The choice of the alloy composition will depend on the exact design requirement. For example, in some embodiments it is suggested that the alloy compositions be chosen such that the strength of alloy B is greater than alloy A. In another embodiment it is suggested that alloy B have a higher fracture toughness than alloy A. In another embodiment it is suggested that alloy A have a higher hardness as compared to alloy B. It should be pointed out that whether alloy A or alloy B is used as a strike/impact surface will depend on the properties of the individual compositions.

In addition to the embodiments described above, it is possible to electro-deposit nanostructured material equally on each side of the substrate. The exact thickness of the individual nanostructured layers in the sandwich can then be achieved by machining or finishing operations such as surface grinding, blanchard grinding, double-disc grinding, lapping, and milling to remove excess material.

In one exemplary embodiment of the invention, the substrate consists of aluminum alloys 7075, 7178 and 7001 in a T6 temper. The nanostructured metal consists of a nickel-iron alloy with iron content in the range of 0-50% by weight. The thickness of aluminum substrate is in the range 0.1 mm to 4.00 mm range. The front layer of nanostructured metal in the range 0.5 mm to 2.0 mm range, and the back layer of nanostructured metal in the range 0 mm to 1.0 mm range.

In the event a large plate of aluminum is used as a substrate, the individual fishing tackle may be cut from the sheet using processes such as water jet, laser, electro-discharge machining, CNC milling, high speed diamond saw cutting and so forth. In one exemplary embodiment, water jet is used for cutting the fishing reel bodies from the large sheet to be assembled by standard mechanical processes such as press-fits and bolts with our without adhesive.

Fishing Tackle Applications

Aspects of the present invention are related to fishing tackle, and in particular to fishing tackle components, such as rods, reels, and guides, coated with nanostructured materials.

Hybrid fishing rods with nanostructured metal applied to the outside of the FRP composite/epoxy system may have several potential advantages. First the impact strength of the hybrid system may be far superior to a rod made from a standalone FRP composite/epoxy system. Second, the nanostructured material can be applied in many different areas and thicknesses, which allows for an infinite number of designed rod actions, and the ability to better control rod action through application of the nanostructured material. Third, the strength-to-weight and weight-to-diameter ratio is improved due to the presence of nanostructured materials. Fourth, the application of a hard, high strength nanostructured material to the outside of the rod reduces the dampening of the epoxy system and increases the feel and sensitivity of the fishing tackle. Other advantages are also provided and anticipated as designs progress for each fishing tackle category.

In some embodiments, a nanostructured material may be applied to the entire fishing rod (see FIG. 9b). Such an application may improve the rod's overall sensitivity as well as strength, especially since only a very thin electro-deposit of nanostructured material is required to prevent localized damage such as nicks and abrasions to the FRP composite, while thicker deposits can augment the power and accuracy of the rod.

In some embodiments, nanostructured material may be applied to the first 12 inches (30 cm) of an end section or tip of a fishing rod to improve the resistance of the tip to breakage while simultaneously improving tip action as felt by the fisherman (see FIG. 9c). While the nanostructured material may increase the overall weight of the rod, the increased weight, because it is only at the tip, may also act to increase the inertia which causes longer casts. Since the point of action is also well defined by the transition from the electro-plated region with the nanostructured material to the non electro-plated region, the cast may also be more consistent, which is a desired property in fishing rods.

In some exemplary embodiments, a nanostructured material may be applied to a middle or center section of a fishing rod, potentially increasing the power of the rod while the casting action is held constant (see FIG. 9d and FIG. 10). This provides for a lightweight rod that may have increased strength for heavier lines, while maintaining a fast action and feel for the fisherman.

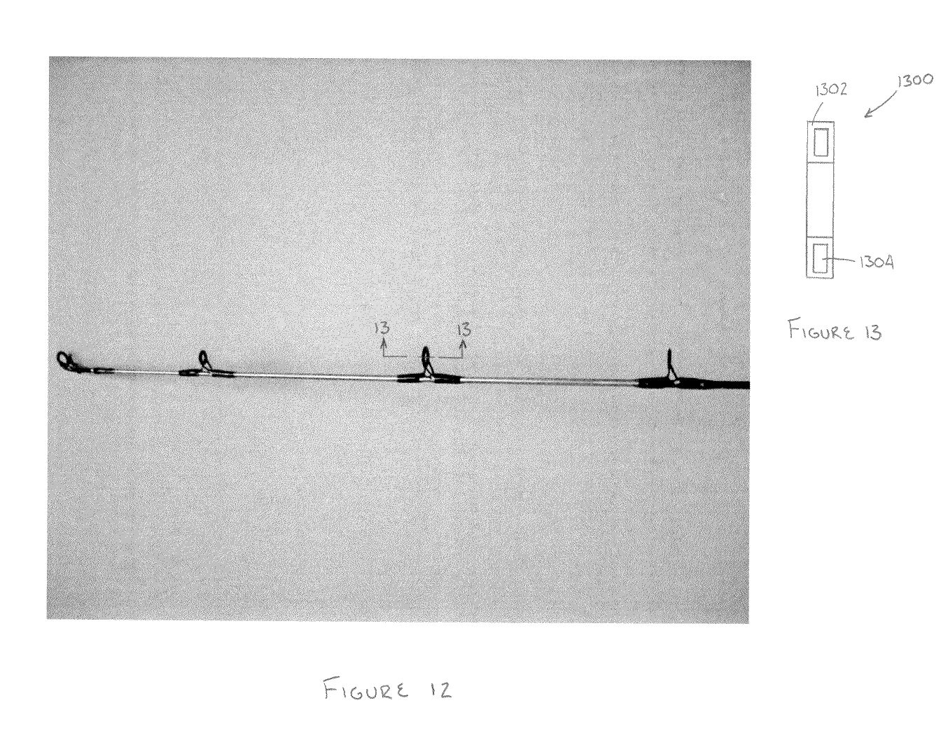

FIGS. 11 and 12 illustrate fishing tackle including fishing rods and guides attached thereto having nanostructure material (shown as a black coating material) applied to all or part of the fishing tackle.

In some embodiments, a fishing reel or reel body may be coated in whole or part with nanostructured materials. Additional advantages may be provided by coating individual fishing reel components in whole or part. Typical reels are made of aluminum or polymers and are relatively thick in cross-section and easily scratched. As described previously, fishing reels coated with nanostructured materials may allow for lighter and/or stronger reels. Such reels may allow for thinner cross sections, and lower strength substrates to be used, resulting in an extremely light reel that retains the feel and stiffness of a typical aluminum reel. Such a coated reel may have improved performance including being lighter and stronger than a comparable aluminum reel. Torque and bending performance of nanostructured reel body components may also be improved, in some cases significantly, depending on the relative deposit thicknesses and the mechanical properties of the substrates which can vary from amorphous and semi-crystalline polymers to aluminum and magnesium alloys. Cross-sectional schematic designs for such a reel body are disclosed in FIGS. 1-7 inclusive, the reel body being identifies as the substrate.

In one exemplary embodiment, a nanostructured material may be applied to the surface of an aluminum reel or reel body allowing for a stronger, stiffer, and/or more scratch resistant reel. A nanostructured material, specifically, nano-nickel, electro-deposited over aluminum or magnesium alloys may will provide improved corrosion resistance of the reel to saltwater, while having a low overall weight due to the lightweight alloy core.

In some embodiments, fishing rod guides may be coated with a nanostructured material. Such a guide may exhibit improved friction performance, be lighter than conventional guides, be tougher and stronger than conventional guides, and have other advantages. Cross-sectional schematic designs of such guides are disclosed in FIGS. 1-7 inclusive, the guide being identified as the substrate.

In one exemplary embodiment an entire guide may be coated with a low friction nano-metal such as n-Ni or n-Co-P with our without additives such as MoS₂ or B₄C to improve the tribological properties of the guide while fresh and salt water fishing line is repeatedly run across the surface. Such an electro-deposit may improve both the coefficient of friction and performance compared to conventional guides.

In another embodiment, and with reference to FIG. 13, a guide 1300 includes a guide frame 1302 and a guide ring 1304 at least partially housed within the guide frame. As shown, the guide ring is completely encased by the guide frame; although, this is not required. At least a portion of one of the guide housing and guide ring can be coated with nanostructured material.

It should be appreciated that the embodiments of the invention described above are provided by way of example, and various other embodiments are contemplated. A practitioner of ordinary skill in the art requires no additional explanation in developing the embodiments described herein but may nevertheless find some helpful guidance regarding characteristics and formation of nanostructured materials by examining the patent application of Palumbo et al., U.S. patent application Ser. No. 11/013,456, entitled “Strong, Lightweight Article Containing a Fine-Grained Metallic Layer” and filed on Dec. 17, 2004, and the patent application of Palumbo et al., U.S. patent application Ser. No. 10/516,300, entitled “Process for Electro-plating Metallic and Metal Matrix Composite Foils, Coatings and Microcomponents” and filed on Dec. 9, 2004, the disclosures of which are incorporated herein by reference in their entirety.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit and scope of the invention. All such modifications are intended to be within the scope of the claims appended hereto or the equivalents thereof. In particular, while certain methods may have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

What is claimed is:

1. A fishing tackle comprising:
a rod;
at least one guide attached to said rod; and
a reel operably connected to said rod,
wherein at least a portion of one of said rod, said at least one guide and said reel is one of externally and internally coated with nanostructured material.

2. A fishing tackle of claim 1, wherein said portion is fully encapsulated with the nanostructured material.

3. A fishing tackle of claim 1, wherein a yield strength of said portion is at least about 600 MPa.

4. A fishing tackle of claim 1, wherein modulus of resilience of said portion is at least about 0.15 MPa.

5. A fishing tackle of claim 1, wherein an elastic limit of said portion is at least about 0.75 percent.

6. A fishing tackle of claim 1, wherein a hardness of said portion is at least about 300 Vickers.

7. A fishing tackle of claim 1, wherein the nanostructured material comprises at least about 2.5 percent by volume of said portion.

8. A fishing tackle of claim 1, wherein said portion coated with the nanostructured material includes an activation layer.

9. A fishing tackle of claim 1, wherein the nanostructured material has a variable thickness.

10. A fishing tackle of claim 9, wherein the thickness of the nanostructured material is between approximately 0.0001 inch (0.00254 mm) and approximately 0.040 inch (1 mm).

11. A fishing tackle comprising:
an elongated rod including a first end section, a second end section and a surface extending longitudinally between said first and second end sections, said surface being at least partially electro-deposited with a nanostructured material, the nanostructured material having a predetermined thickness for selectively improving action, power, and casting distance of said elongated rod.

12. A fishing tackle of claim 11, wherein the nanostructured material electro-deposited on said surface has a first thickness and a second thickness.

13. A fishing tackle of claim 11, wherein the nanostructured material is electro-deposited on said surface along at least the first six inches measured from one of the first end section and the second end section.

14. A fishing tackle of claim 11, wherein the nanostructured material is electro-deposited on said surface along at least the first twelve inches measured from one of the first end section and the second end section.

15. A fishing tackle of claim 11, wherein the nanostructured material is electro-deposited on said surface along at least the first eighteen inches measured from one of the first end section and the second end section.

16. A fishing tackle of claim 11, wherein the nanostructured material is electro-deposited on said surface along at least the first twenty-four inches measured from one of the first end section and the second end section.

17. A fishing tackle of claim 11, wherein the nanostructured material is electro-deposited on said surface along a center portion of said elongated rod.

18. A fishing tackle of claim 11, wherein the elongated rod is a unitary member.

19. A fishing tackle comprising:
a rod and at least one guide attached to said rod, said at least one guide being at least partially electro-deposited with a nanostructured material, the nanostructured material having a predetermined thickness for selectively improving friction, stiffness, and corrosion resistance of the at least one guide.

20. A fishing tackle of claim 19, wherein said guide includes a guide ring and a guide frame, said guide ring being at least partially housed within said guide frame, the nanostructured material being electro-deposited on at least a portion of said guide ring.

21. A fishing tackle of claim 19, wherein said at least one guide is fully encapsulated with the nanostructured material, the nanostructured material at least partially securing said at least one guide to said rod.

22. A fishing tackle comprising:
a reel including a reel body, at least a portion of said reel body being electro-deposited with a nanostructured material, the nanostructured material improving stiffness, torsional defection, corrosion resistance, weight, and casting distance of said reel.

23. A fishing tackle of claim 22, wherein said portion of said reel body is externally coated with the nanostructured material.

24. A fishing tackle of claim 23, wherein said portion of said reel body is internally coated with the nanostructured material.

25. A method of manufacturing a fishing tackle comprising:
providing at least one of an elongated rod including a rod body, a reel including a reel body and a guide including a guide body;
forming at least a portion of at least one of said rod body, said reel body and said guide body as a substrate; and
coating said substrate, at least in part, with a nanostructure material.

26. A method of claim 25, further comprising processing the substrate to obtain a predetermined thickness of the nanostructured material.

27. A method of claim 26, further comprising varying the thickness of the nanostructured material.

28. A method of claim 25, further comprising activating at least a portion of the substrate prior to coating with the nanostructure material.

29. A method of claim 25, further comprising forming the nanostructured material into a shell, the shell being a substrate for a second material to be coated thereon.
